(19) United States
(12) Patent Application Publication
(10) Pub. No.: US 2026/0158542 A1
(43) Pub. Date: Jun. 11, 2026

(54) MOLD FOR MANUFACTURING AN ENGINE CASTING PART FOR A VEHICLE FROM VERMICULAR CAST IRON ALLOY, PROCESS FOR MANUFACTURING AN ENGINE CASTING PART FOR A VEHICLE FROM VERMICULAR CAST IRON ALLOY, AND PROCESS FOR ASSEMBLING A VEHICLE ENGINE BY THE COMBINATION OF PARTS MADE FROM VERMICULAR CAST IRON ALLOY AND PARTS MADE FROM COMPOSITES

(71) Applicant: TUPY S.A., Joinville (BR)

(72) Inventors: Carlos de Souza CABEZAS, Joinville (BR); Eraldo COMINATO, Joinville (BR); Jeferson Alexandre BRZOSTEK, Joinville (BR); Luis Carlos GUEDES, Joinville (BR); Cássio Luiz Francisco DE ANDRADE, Joinville (BR)

(73) Assignee: TUPY S.A., Joinville, SC (BR)

(21) Appl. No.: 18/707,758

(22) PCT Filed: Nov. 8, 2021
(86) PCT No.: PCT/BR2021/050488

§ 371 Date: May 6, 2024

(51) Int. Cl. B22C 9/24; B22C 9/02; B22C 9/10; B22D 15/02; B33Y 80/00

(52) U.S. Cl. CPC B22C 9/24; B22C 9/02; B22C 9/10; B22D 15/02; B33Y 80/00

(57) ABSTRACT

The present invention relates to a mold for manufacturing vehicle engine cast part with vermicular cast iron alloy and a process for manufacturing vehicle engine cast part with vermicular cast iron alloy capable of manufacturing parts with high strength and lightness using said mold, without prejudice to the other thermal and mechanical properties of the part. In addition, the present invention relates to a vehicle engine assembly process from the combination of parts made with vermicular cast iron alloy and parts made of composites producing a light and high strength engine, having weight equal to or less than the weight of a conventional aluminum engine.

### FIELD OF THE INVENTION

The present invention relates to a mold for manufacturing vehicle engine cast part, a manufacturing process of vehicle engine cast part and a vehicle engine assembly process, more specifically the manufacturing of the engine cast part is made, using the aforementioned mold, from a vermicular cast iron alloy (CGI—Compacted Graphite Iron) and the vehicle engine assembly process is made from the combination of the parts made from vermicular cast iron alloy with parts made from composites.

### BACKGROUND OF THE INVENTION

The search for high mechanical strength cast alloys has been intense by the automotive industry, aiming to reduce vehicle weight and increase engine power. Recently, cast iron alloys capable of exceeding 500 MPa strength limits have been developed, thus bringing new opportunities for engine element (parts) designers as it has become possible to manufacture engine parts of complex geometries and even lighter.

An example of a vermicular cast iron alloy capable of exceeding such resistance limits and related to the manufacture of engine parts, specifically the cylinder head, can be seen in BR1020160211395, authored by Applicant. In the aforementioned BR1020160211395, a vermicular cast iron alloy of high mechanical strength is revealed, more specifically above 500 MPa, wherein there is the addition of molybdenum, copper and tin, in balanced and appropriate proportions, to the alloy parts already conventionally used in vermicular cast iron.

JP1984146606 discloses a vermicular cast iron alloy used in the manufacture of a cylinder liner with high abrasion resistance for an internal combustion engine, in particular for a diesel engine. The document US2011132314 reveals a lamellar cast iron alloy used in the manufacture of engine cylinder heads. Also, the document U.S. Pat. No. 3,421,886 discloses a cast iron alloy that can be used, among several applications, in the manufacture of engine cylinder heads. However, these documents reveal cast iron alloys that are not capable of reaching the strength limits above 500 MPa and, therefore, these alloys cannot be considered for the manufacture of even lighter and stronger engine parts.

In addition, although all of the aforementioned documents are related to the use of cast iron alloys in vehicle parts casting processes, these documents do not address the obvious difficulties in the construction of lighter and high mechanical strength vermicular cast iron parts, such as the need for slimmer structural elements and thinner internal wall thicknesses, as well as the difficulties in maintaining the soundness of parts that are so difficult to manufacture during the casting process.

In this sense, it should be noted that the development of increasingly lighter and more resistant engines leads to increasingly accentuated construction difficulties. These difficulties include, for example:
the higher surface tension of vermicular cast irons, due to the magnesium content, which makes it difficult the filling of the cast part;
ensure a temperature control in the part, essential for the homogeneity of the mechanical and physical properties and its internal soundness;
thin walls with small dimensional tolerances involved;
   the unavailability of a database of physical, mechanical and thermomechanical properties of high strength vermicular cast iron alloys, which makes it impossible to simulate the performance of the part in operation using computational tools;
obtaining the maximum thermal conductivity of high strength vermicular cast iron, because when one seeks to increase the mechanical properties of a cast iron alloy, there is a tendency to reduce its thermal conductivity;
considering the complex geometry and thin walls of the parts, there is a greater possibility of cracks and residual stresses, in addition to increasing the tendency to casting faults, such as shrinkage and porosity, and the formation of iron carbide;
increased difficulty in avoiding microstructural faults in thin walls, such as iron carbides and excess of nodular graphite, the main problems are listed in the table below:

| Carbides | Nodular excess |
|---|---|
| Machinability is exponentially worse | Machining worsening |
| Reduction of tensile strength | Castability - increased porosity |
| High wear of parts, for example, | Decreasing in thermal conductivity |
| piston ring of engines | Damage (abrasions) to the part |
| | walls, for example, inner diameter |
| | walls of engine cylinders |

increasing reduction in the machinability of alloys with greater mechanical strength.

In other words, to obtain lighter engine parts, just the development of a vermicular cast iron alloy suitable for the manufacture of high strength and light castings would not be enough. It is necessary to develop casting molds provided with characteristics that enable the manufacture of increasingly lighter and more resistant parts without, however, harming the competitiveness of manufactured parts, since current casting molds cannot deliver parts with greater precision in the geometric dimensions of the parts with satisfactory surface quality. In other words, the casting mold must contribute to obtaining a cast part that achieves excellent properties of lightness and strength without making the process too expensive.

Patent document US20110185993A1, for example, discloses methods of manufacturing cast iron articles of different morphologies, including vermicular cast irons. However, there is no concern in that document to reveal or suggest a mold that adopts the necessary measures to ensure that all these difficulties are overcome. In fact, there is no indication that the manufactured articles are capable of achieving the desired mechanical strength and lightness.

In this context it is developed the mold for manufacturing a vehicle engine cast part with vermicular cast iron alloy and the associated manufacturing process, according to the present invention.

In addition to the development of a mold and a casting process with the characteristics described above, in order to make further progress in reducing the final weight of an engine, other measures can be taken. Thus, it is noted that the use of composites and thermoplastics, taking advantage of the rigidity of the high strength vermicular cast iron alloy, also contributes to weight reduction.

It is observed that the need to develop increasingly lighter engines is very relevant in the context of internal combustion engines and hybrid engines, due at least to the need of meeting the weight limitation requirements of vehicle components, increasing the autonomy of the systems or further due to space constraints. It is also important to note that a lighter engine reduces the vehicle's total weight, which leads to lower fuel consumption and, consequently, to a lower level of emission of polluting gases.

Traditionally, engines manufactured of aluminum were considered a reference in lightness. Thus, it can be considered as a benchmark an aluminum engine with a weight similar to that desired to be obtained with the engine manufactured from the combination of a vermicular cast iron alloy and thermoplastic or composite components. Importantly, due to the density of materials, it is extremely difficult to replace aluminum in light engines. Specifically, the density of a cast iron alloy (about 7.2 g/cm³) is almost three times the density of an aluminum alloy (about 2.7 g/cm³).

In this sense, the patent document U.S. Pat. No. 10,724,469B2 reveals, in a superficial way, the use of a combination of vermicular cast iron alloy and polymeric components. However, patent document U.S. Pat. No. 10,724,469B2 is not concerned with reducing weight in such a way that it reaches a final weight equal to or less than the weight of a conventional aluminum engine.

In this context the vehicle engine assembly process was developed from the combination of parts made with vermicular cast iron alloy and parts made of composites, according to the present invention.

### Objectives of the Invention

In this sense, it is an objective of the present invention to provide a mold for manufacturing a vehicle engine cast part with vermicular cast iron alloy and associated manufacturing process, in which said vehicle engine cast part is capable of achieving a mechanical strength of at least 500 MPa, more preferably of at least 550 MPa, without affecting the properties of rigidity, hardness, efficiency in heat transfer, machinability, among others.

In addition, it is still an objective of the present invention to provide a vehicle engine assembly process from the combination of parts made of vermicular cast iron alloy and parts made of composites or thermoplastics, aiming the production of an engine that is both lightweight and durable, with final weight equal to or less than that of a conventional aluminum engine.

### SUMMARY OF THE INVENTION

The present invention provides a mold for manufacturing a vehicle engine cast part with a vermicular cast iron alloy, comprising:
modular external elements and sand core internal elements manufactured separately,
   wherein at least one mold element is manufactured by additive manufacturing, and the elements are assembled to form a casting cavity for the casting of a part;
wherein the mold elements enable a part of variable wall thickness, the wall thickness being at least 1.5 mm, and wherein the mold elements change the temperature and filing velocity of a cast iron alloy during pouring and change the cooling rate of the cast part after the pouring;
wherein the casting cavity of the mold has regions of allowance for final machining and contours with regions for deposition of fillets.

According to additional or alternative embodiments of the present invention, the following features, and possible variants thereof, may also be present alone or in combination:
the minimum wall thickness of the part is between about 1.7 and about 2.7 mm;
the temperature of the poured cast iron alloy varies between about 1320 and about 1480° C.;
the filing velocity of the poured cast iron alloy varies between about 0.3 and about 1.5 m/s, preferably between about 0.3 and about 0.7 m/s;
the mold maintains a uniform temperature distribution in the cast part after pouring the alloy;
the cooling rate varies between about 10 and about 75° C./s, according to the wall thickness of the cast part and the regions of allowance, tending to form different microstructures in the cast part;
contours with regions for deposition of fillets are located at corner locations in the casting cavity of the mold.

In addition, the present invention provides a manufacturing process of vehicle engine cast part with vermicular cast iron alloy with the following steps:
providing said casting mold;
continuously controlling the composition of a cast iron alloy;
pouring the cast iron alloy into the casting mold;
cooling the mold with the cast iron alloy at room temperature, wherein the mold changes the cooling rate of the part, and wherein the cast part is provided with an external geometry with regions of allowance and mounting flanges; and
machining the cast part to remove the allowance.

According to additional or alternative embodiments of the present invention, the following features, and possible variants thereof, may also be present alone or in combination:
the cooling of the mold occurs in two steps:
   i) solidification of the cast iron alloy to form the cast part; and
   ii) cooling the cast part to room temperature,
the step of controlling the composition of a cast iron alloy is done by an operational system;
in the pouring step, the cast iron alloy enters the casting cavity of the mold through the base of the mold;
the cast part is engine block;
cylinder inner diameter walls of the engine block have a microstructure of low nodularity, less than 20%;
external walls of the engine block have a high nodularity microstructure, greater than 20%.

Finally, the invention provides a vehicle engine assembly process from the combination of parts made of vermicular cast iron alloy and parts made of composites with the following steps:
providing at least one cast part manufactured by the manufacturing process of vehicle engine cast part with vermicular cast iron alloy of the present invention;
providing at least one part formed by a composite; and
coupling the at least one composite part to the at least one cast part through the mounting flanges.

According to additional or alternative embodiments of the present invention, the following features, and possible variants thereof, may also be present alone or in combination:
the composite part is made of a thermoplastic material.
the engine is suitable for use in an internal combustion system and/or a hybrid system.

### BRIEF DESCRIPTION OF FIGURES

The present patent of invention is now illustrated in detail based on the figures listed below, wherein:

FIGS. 1A and 1B show an exploded view of the casting mold and an assembled configuration of the mold according to the present invention, in which the modular external elements and the sand core internal elements can be seen;

FIG. 2A shows images of sand core internal elements of the mold illustrated in FIGS. 1A and 1B;

FIG. 2B shows images of the tools to produce the mold illustrated in FIGS. 1A and 1B, the assembled mold and a configuration of the mold inserted in a sandbox;

FIG. 2C shows images of an engine block produced with the mold illustrated in FIGS. 1A and 1B;

FIG. 3A shows a flowchart of the manufacturing process of an engine casting for a vehicle with a vermicular cast iron alloy according to the present invention;

FIG. 3B shows a detail of the flowchart of FIG. 3A;

FIG. 3C shows a flowchart of the vehicle engine assembly process from the combination of parts made with vermicular cast iron alloy and parts made of composites according to the present invention;

FIG. 4 shows a simulation of the temperature profile in a part during the manufacturing process of an engine cast part according to the present invention;

FIG. 5 illustrates an engine block manufactured of vermicular cast iron alloy by the manufacturing process according to the present invention, adapted to be used in a hybrid system;

FIGS. 6A and 6B shows a side view and a perspective view of the engine manufactured in accordance with the present invention; and

FIG. 7 shows images of the engine block illustrated in FIGS. 6A and 6B with composite covers mounted on the outside of the block, according to the assembly process of the present invention, used in an internal combustion system.

### DETAILED DESCRIPTION OF THE INVENTION

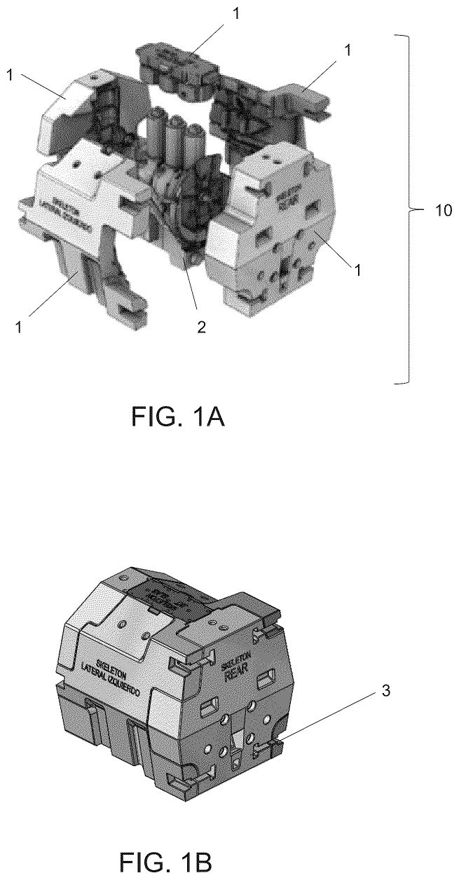

FIGS. 1A and 1B illustrate an exploded view and an assembled configuration of an exemplary mold 10 for manufacturing the vehicle engine cast part with vermicular cast iron alloy in accordance with the present invention.

The mold 10 can provide parts of variable wall thickness, the wall thickness being at least 1.5 mm, wherein the mold can vary the filing velocity and temperature of a cast iron alloy during pouring, as well as can vary the cooling rate of the cast part after pouring, since the rate of heat transfer between the interior of the mold 10 and the outside environment depends on the wall thickness between these means. In this sense, the mold manages to maintain the uniformity of temperature in the part.

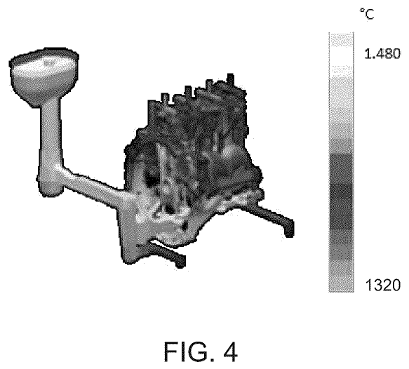

The temperature of the cast iron alloy during casting can vary between 132° and 1480° C. and the filing velocity may vary between about 0.3 and 1.5 m/s, preferably between 0.3 and 0.7 m/s. The temperature variations of the cast part to be produced in the mold 10 can be seen in FIG. 4, which illustrates this characteristic after pouring the cast iron alloy to manufacture an engine block. It is essential that the temperature distribution of the cast part in mold 10 is as uniform as possible. In this sense, the cooling rate of the cast part may vary between 1° and 75° C./s. The temperature, velocity and cooling rate values are obtained through simulation software for the casting area, widely known and used by a person skilled in the art.

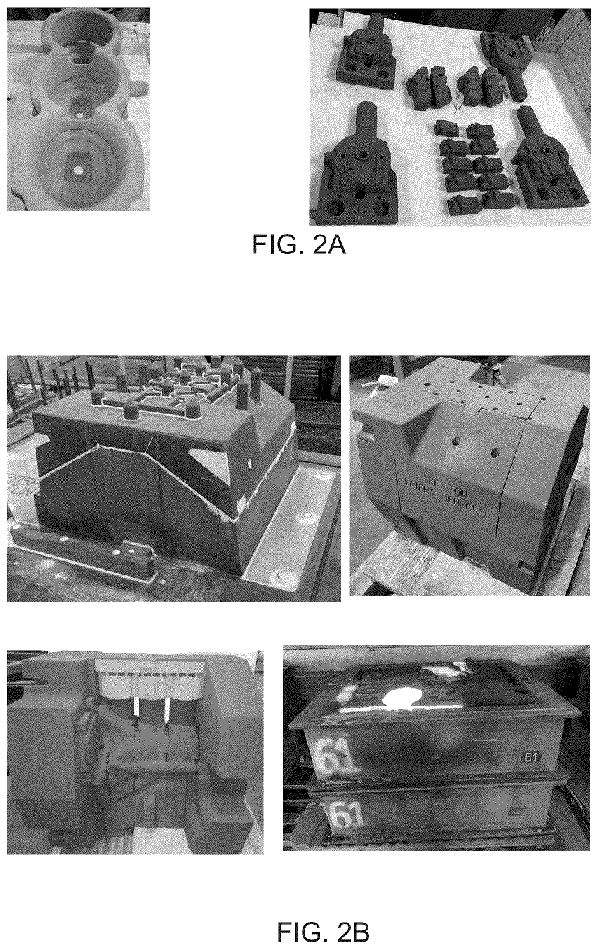

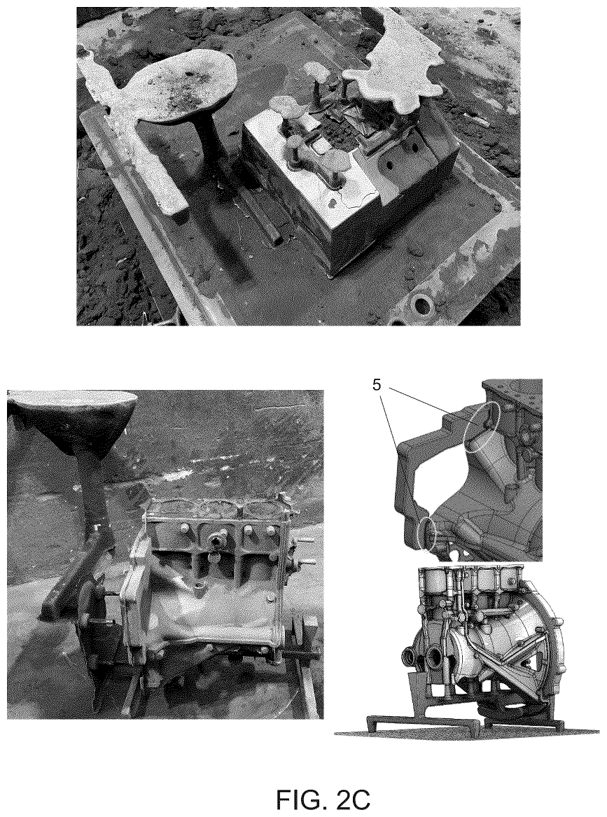

Furthermore, the mold 10 comprises modular external elements 1 and sand core internal elements 2 which, once assembled, form a casting cavity for forming a cast part. FIG. 2A shows examples of sand core internal elements 2 of mold 10 and FIG. 2B shows examples of tools for producing the mold 10 illustrated in FIGS. 1A and 1B. The sand core internal elements 2 are responsible for the formation of holes and voids in the part. Both the modular external elements 1 and the sand core internal elements 2 can be formed by an additive manufacturing process using sand as its fabrication material. Additive manufacturing assists in the manufacture of molds capable of manufacturing robust cast parts with thin walls with a minimum thickness of at least 1.5 mm, preferably between 1.7 and 2.7 mm, substantially contributing to reducing the weight of the cast part manufactured. Preferably, all external and internal elements are produced by the additive manufacturing process and with Cerabead material, however, other production methods can be used for the production of mold elements such as, for example, permanent molds produced from templates with the shape of the part to be produced, cold box, furan process, pep-set, among others. After assembling the mold elements, the closed mold can be placed in a sandbox (“green sand flasks”), as illustrated in FIG. 2B, to ensure the coupling of the elements during the manufacture of the parts on the assembly line, but there is the possibility of the alloy being poured directly into the sand core package, eliminating the sandbox.

The great advantage of using additive manufacturing for manufacturing mold lies in the fact that the mold can be manufactured without worrying about the need for exit angles for its extraction, as occurs in conventional processes, since the modular external elements 1 and the sand core internal elements 2 are manufactured separately and assembled to form the mold. This allows the mold to manufacture much more complex parts, with extremely thin walls and smaller dimensional tolerances. In the additive manufacturing process, cast part geometry is independent of tools with its geometry limitations and exit angles. This technology allows the manufacture of sand cores with more precise dimensions and, consequently, thinner walls and parts with greater dimensional precision, which are important characteristics for producing lighter parts.

It is noted that, in the conventional sand casting process, when pressing a model against a sand molding box to form the mold, it is necessary the existence of exit angles so that, when removing the template, there is no breakage of interior walls (also called sand cakes) or mold corners. This prevents the mold from being able to manufacture complex cast parts with thin walls and small dimensional tolerances, without making the process too expensive. In contrast, the mold 10 according to the present invention, being able to provide parts with such geometric characteristics, enables the manufacture of extremely light and resistant parts, without harming the cost of the project, thus maintaining its competitiveness.

The mold 10 also has in its casting cavity regions of allowance, contours with regions for deposition of fillets 5 (fillet radil). The allowance regions (additional mass) will receive the liquid metal which, once solidified, will form allowance regions in the cast part.

The allowance regions are responsible for helping to cool the part in its solid state to room temperature. As those skilled in the art will readily recognize, the microstructure of a cast iron alloy is directly influenced by the way it is cooled, both during the solidification phase and during the cooling phase to room temperature.

The contours with regions for deposition of the fillets 5 are places with corners in the cavity of the mold 10 that present residual stress. The fillets alleviate these residual stresses, contributing to an increase in the mechanical strength of the part, and also contributing to the reduction of turbulence in alloy pouring during mold filling 10. The regions for deposition of the fillets 5 are determined by specific software that perform computational fluid dynamic (CFD) modeling and available on the market.

In this sense, the above-mentioned allowance regions are positioned in selected locations so that the desired microstructures are obtained.

It is observed that the mold 10 is a mold that is destroyed for the extraction of the casting. FIG. 2C shows images of an engine block produced with the mold illustrated in FIGS. 1A and 1B after the mold is destroyed. After its destruction, the mold sand can be reused to manufacture new molds.

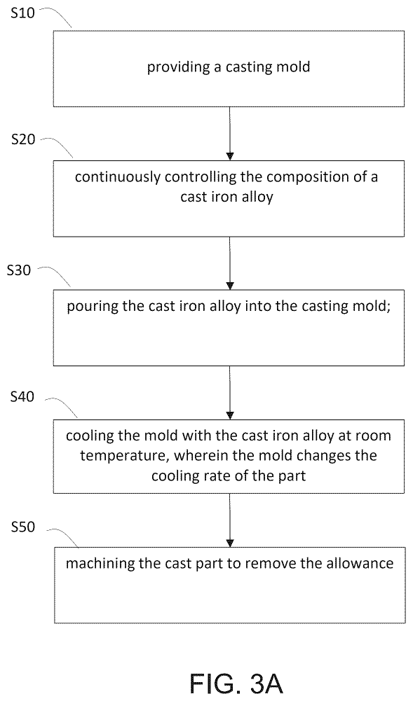

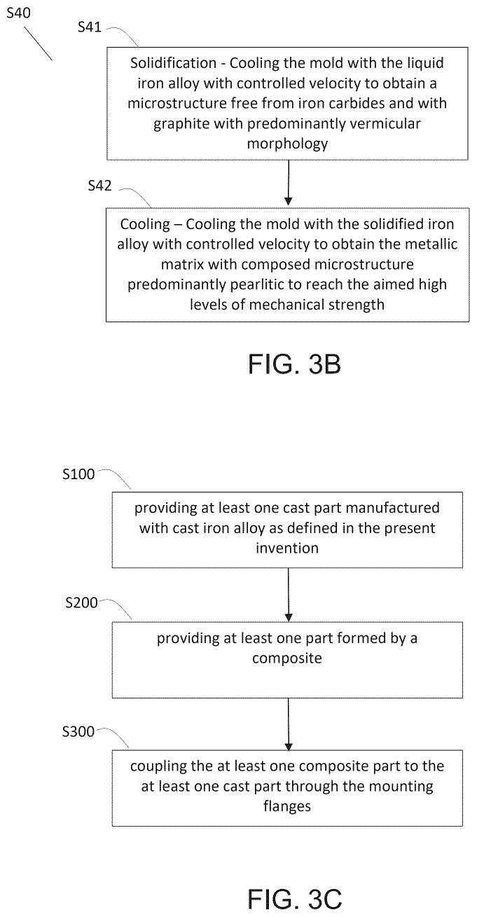

Referring now to FIG. 3A, it is shown a flowchart of the process for manufacturing a vehicle engine cast part with a vermicular cast iron alloy in accordance with the present invention.

In said manufacturing process, a provision step S10 of the mold 10 according to the present invention is provided.

Then, there is a continuous control step S20 of the composition of a cast iron alloy to be poured. This control step is carried out continuously so that the metallurgical characteristics of the alloy are adequate throughout the pouring. Control is done through an operational system of specific software and available on the market.

Then, there is a step of pouring a vermicular cast iron alloy S30 into mold 10. This pouring step takes place in a gating system, developed by simulation, capable of preventing the formation of carbides in selected regions of the cast part, such as thin external walls, to avoid turbulence, which could lead to manufacturing defects, such as arising from incomplete pouring of mold 10, and from minimizing residual stresses, particularly at thick and thin wall joints at lower ends of the cast part.

For this purpose, the aforementioned gating system feeds the vermicular cast iron alloy directly into specific parts of the part. For example, direct supply can be made to main bearings of an engine block, maximizing heat flow to cylinder inner diameter walls, or further, thin outer regions and a gearbox rear flange to minimize formation of carbides. Preferably, the entrance of the cast iron alloy into the casting cavity of the mold 10 is made by the base 3 of the mold 10.

After pouring step S30, a cooling step S40 occurs, in which the mold 10 with the vermicular cast iron alloy is cooled to room temperature with the cooling rate being changed by the mold, resulting in a cast part provided with an external geometry with allowance regions in allowance regions for final machining of mold 10 and mounting flanges.

As previously mentioned, the cooling rate of the part varies according to the wall thickness of the cast part and the allowance regions, tending to form different microstructures in the cast part. For example, in the manufacturing process of an engine block, it is interesting to add allowance in outer upper regions that will be later machined, so that there is slower cooling and, consequently, the homogeneity in the formation of microstructures of vermicular cast iron (CGI) of low nodularity (for example, less than 20%) in the cylinder inner diameter walls, which are thermally stressed. Naturally, since the addition of allowance takes place in regions that will be machined, this addition does not increase the final weight of the block. Also in the example of the engine block, through a thinner wall thickness, it is possible to obtain, in a homogeneous way, a high nodularity (for example, greater than 20%) in the main bearings on external walls to optimize their strength, durability and noise, vibration and harshness (NVH) characteristics. Due to its higher cooling rate, the external walls of the engine block have a high nodularity microstructure.

It is also important to point out that the cast part cooling process can be divided into two steps, which are equally important to obtain a cast part with the desired qualities. As illustrated in FIG. 3B, the first step occurs during the solidification of the liquid metal, and this step needs to be controlled so that an optimal heat extraction rate is obtained, aiming at the desired graphite microstructure (solidification according to the stable system in the Fe—C diagram), wherein the graphite must have a predominantly vermicular morphology (minimum of 80%), with a maximum of 20% of nodular graphite, and with a metallic matrix completely free of iron eutectic carbides (ledeburite, formed in solidification according to the metastable system in the Fe—C system). Getting this kind of structure depends on the following variables: 1) chemical composition of the alloy, mainly magnesium, sulfur and oxygen contents, in addition to carbon and silicon contents, and absence of strong elements that form carbides such as chromium and molybdenum; 2) inoculation with alloys that promote the formation of graphite upon solidification in adequate amounts, as low amounts of inoculants do not prevent the formation of carbides and high additions increase the amount of nodular graphite in the microstructure; and 3) the cooling rate, in which if the heat extraction rate is too high, eutectic carbides (ledeburite) can be formed at the expense of graphite formation, which is undesirable. To reduce the heat extraction rate to ensure solidification with graphite formation, higher metal casting temperatures can be used inside the mold, aiming to soak the mold and sand cores with heat, thus reducing the heat extraction rate by the molds and sand cores and allow the solidification rate to occur according to the stable system, that is, with the formation of graphite in the microstructure. The other way to reduce the rate of heat extraction by the mold is to change the composition of the external elements (sand, clay, coal dust, water and additives) and internal/sand core (sand, resins, additives) of the mold, manufactured by manufacturing additive, so that they have low thermal conductivity, reducing heat extraction from the mold elements at high velocities and allowing solidification to occur at velocities suitable for the formation of graphite in the microstructure. Furthermore, under conditions of high heat extraction, it is possible for the alloy to solidify before the entire mold is filled. The second step occurs after solidification, when the cast part is cooled in solid state to room temperature. At this point, it is necessary to have a control, as too slow cooling can lead to the formation of a ferritic microstructure, which is undesirable for the manufacture of parts with the characteristics of high strength according to the present invention. For the desired characteristics to be obtained, it is necessary to obtain a pearlitic microstructure. However, very high cooling rates can lead to residual stresses, which are particularly harmful for thin walls.

It is noteworthy that the mold 10, used in the manufacturing process of the present invention, was developed in such a way as to obtain adequate cooling rates (or control of heat loss) in both the first and second steps, so that a light part, resistant and without defects is produced.

Finally, there is a machining step S50 of the cast part to remove the allowance, so that the final weight of the part is not influenced by the addition of original mass.

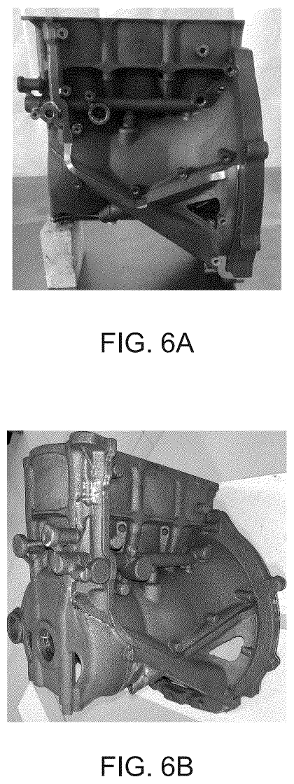

The manufacturing process of the present invention can produce cast part with thin wall thicknesses of at least 1.5 mm. An example of a cast part manufactured using the manufacturing process of the present invention can be seen in FIGS. 6A and 6B, which illustrate an engine block used in an internal combustion system. In this illustrative and non-restrictive example of the present invention, the alloy disclosed in application BR1020160211395, the CGI 500 alloy, is used to provide thin wall thicknesses of the cast part to be produced of at least 1.5 mm. With the thinner walls, the air circulation area between cylinder inner diameter walls is larger compared to aluminum blocks, with an area increase of about 2.25 times.

A fundamental advantage brought about by the replacement of aluminum alloys by vermicular cast iron alloys in the production of engine parts is related to the reduction of energy and CO₂ consumption produced during the alloy manufacturing process. According to a recent study by Cranfield University (M. R. Jolly, K. Salonitis, M. Gonçalves; “Cast Iron or Aluminium—Which Cylinder Block Material is Best for the Environment?”, 2017), it was found that an amount of energy between 879 and 1,238 MJ was necessary to produce engine blocks with cast iron alloys, while engine blocks produced with aluminum alloys used between 1,594 and 4,572 MJ. In relation to CO₂ emission, the production of engine blocks made from cast iron alloys emitted less than 2,900 kg of CO₂ per ton of produced blocks, while the production of engine blocks made from aluminum alloys emitted up to 9,180 kg of CO₂ per ton of blocks produced. Therefore, the production of engine blocks made from cast iron alloys reduced energy consumption by more than 80% and CO₂ emission of at least 70%, compared to the production of engine blocks produced made of aluminum alloys.

Referring now to FIG. 3C, it shows a flowchart of the vehicle engine assembling process from the combination of parts made of compacted iron alloy and parts made of composites according to the present invention. Preferably, a set of functional composite components is used in the present invention.

In said vehicle engine assembly process, a provision step S100 of parts made with vermicular iron alloy, manufactured from said vehicle engine cast process, according to the present invention, occurs.

In addition, a provision step S200 of parts made of composites takes place. Composite parts can be made, for example, from polymers, carbon fibers, glass fibers, thermoplastic materials etc.

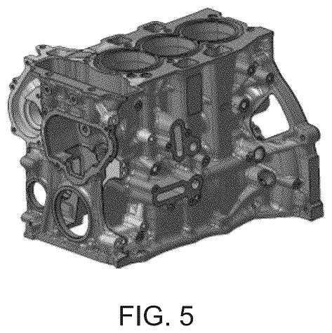

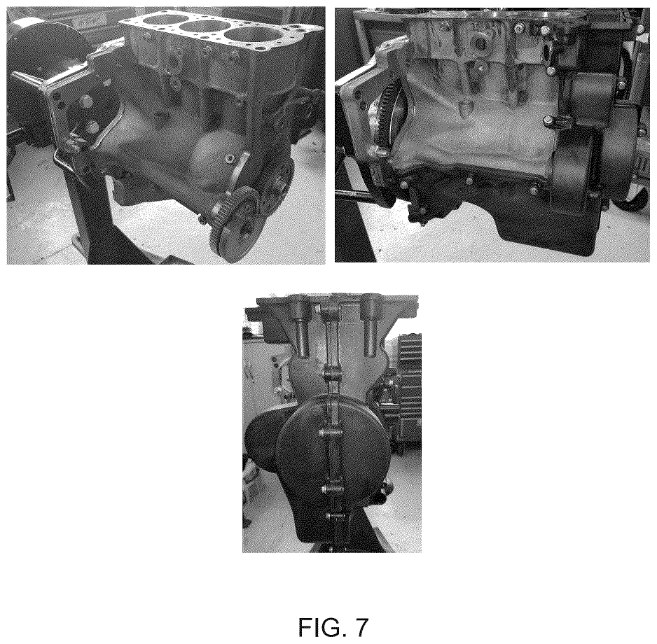

Finally, there is an assembly step (coupling) S300 of the parts made from composites to the parts made with vermicular iron alloy through mounting flanges, wherein one or more functional composite parts are coupled to the cast block using the flanges of connection designed for this, in order to obtain an engine with excellent thermal and mechanical properties, such as a resistance limit with a minimum of 500 MPa, more preferably a minimum of 550 MPa, and with a weight equal to or less than the weight of a state of the art conventional aluminum engine which, as those skilled in the art will readily recognize, has inferior mechanical properties than the vermicular cast iron alloy. It is worth noting that, also in benefit of reducing the project cost, the iron alloys suitable for the present invention have lower production costs compared to aluminum. The engine obtained can, for example, be used in an internal combustion system and/or a hybrid system (internal and electric combustion). Examples of engines assembled according to the assembly process of the present invention can be seen in FIGS. 5, 6A, 6B and 7, which show images of engines used in hybrid systems and internal combustion systems. FIG. 7 shows perspective images of the engine block with composite covers mounted on the outside, and a side view showing only the composite covers.

The process developed and disclosed in the present application, containing the techniques and methods described herein, ensure the reproducibility of the product in serial production.

It is important to emphasize that the above description has the sole purpose of describing, by way of example, the particular embodiment of the invention in question. Therefore, it becomes clear that modifications, variations and constructive combinations of elements that perform the same function in substantially the same way to achieve the same results, remain within the scope of protection delimited by the appended claims.

1. Mold for manufacturing vehicle engine cast part with vermicular cast iron alloy, CHARACTERIZED by comprising:
modular external elements and sand core internal elements manufactured separately,
wherein at least one mold element is manufactured by additive manufacturing, and the elements are assembled to form a casting cavity for the casting of a part;
wherein the mold elements provide a part of variable wall thickness, the wall thickness being at least 1.5 mm, and wherein the mold elements change the temperature and filing velocity of a cast iron alloy during pouring and change the cooling rate of the cast part after the pouring;
wherein the casting cavity of the mold has regions of allowance for final machining and contours with regions for deposition of fillets.

2. Mold, according to claim 1, CHARACTERIZED in that the minimum wall thickness of the part is between 1.7 and 2.7 mm.

3. Mold, according to claim 1, CHARACTERIZED in that the temperature of the poured cast iron alloy varies between 132° and 1480° C.

4. Mold, according to claim 1, CHARACTERIZED in that the filing velocity of the poured cast iron alloy varies between 0.3 and 1.5 m/s, preferably between 0.3 and 0.7 m/s.

5. Mold, according to claim 1, CHARACTERIZED in that the mold maintains a uniform temperature distribution in the cast part after pouring the alloy.

6. Mold, according to claim 1, CHARACTERIZED in that the cooling rate varies between 1° and 75° C./s, according to the wall thickness of the cast part and the regions of allowance, tending to form different microstructures in the cast part.

7. Mold, according to claim 1, CHARACTERIZED in that the contours with regions for deposition of fillets are located at the corner locations in the casting cavity of the mold.

8. Manufacturing process of vehicle engine cast part with vermicular cast iron alloy CHARACTERIZED by the steps of:
providing a casting mold as defined in any one of the preceding claims;
continuously controlling the composition of a cast iron alloy;
pouring the cast iron alloy into the casting mold;
cooling the mold with the cast iron alloy at room temperature, wherein the mold changes the cooling rate of the part, and wherein the cast part is provided with an external geometry with regions of allowance and mounting flanges; and
machining the cast part to remove the allowance.

9. Manufacturing process, according to claim 8, CHARACTERIZED in that the cooling of the mold occurs in two steps:
solidification of the cast iron alloy to form the cast part; and
cooling the cast part to room temperature.

10. Manufacturing process, according to claim 8, CHARACTERIZED in that the step of controlling the composition of a cast iron alloy is done by an operational system.

11. Manufacturing process, according to claim 8, CHARACTERIZED in that at the pouring step, the cast iron alloy enters the casting cavity of the mold through the base of the mold.

12. Manufacturing process, according to claim 10, CHARACTERIZED in that the cast part is an engine block.

13. Manufacturing process, according to claim 12, CHARACTERIZED in that cylinder inner diameter walls of the engine block have a microstructure of low nodularity, less than 20%.

14. Manufacturing process, according to claim 12, CHARACTERIZED in that external walls of the engine block have a microstructure of high nodularity, greater than 20%.

15. Vehicle engine assembly process from the combination of parts made of vermicular cast iron alloy and parts made of composites CHARACTERIZED by:
providing at least one cast part manufactured by the manufacturing process of vehicle engine cast part with vermicular cast iron alloy defined in claim 8;
providing at least one part formed by a composite; and
coupling the at least one composite part to the at least one cast part through the mounting flanges.

16. Engine assembly process, according to claim 15, CHARACTERIZED in that the composite part is made of a thermoplastic material.

17. Engine assembly process, according to claim 15, CHARACTERIZED in that the engine is suitable for use in an internal combustion system and/or in a hybrid system.
